(19) United States
(12) Patent Application Publication
(10) Pub. No.: US 2026/0074871 A1
(43) Pub. Date: Mar. 12, 2026

(54) TECHNIQUES FOR COMMUNICATING A TRANSPORT BLOCK OVER MULTIPLE LAYERS IN WIRELESS COMMUNICATIONS

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US)

(21) Appl. No.: 18/828,910

(22) Filed: Sep. 9, 2024

(51) Int. Cl. H04L 5/00; H04L 1/00; H04W 72/231

(52) U.S. Cl. CPC H04L 5/0094; H04L 1/0003; H04L 5/0023; H04W 72/231

(57) ABSTRACT

Aspects described herein relate to receiving, from a network node, an assignment of multiple subbands associated with a virtual carrier for receiving or transmitting communications or DCI scheduling communications, and receiving or transmitting communications over the multiple subbands, where the communications include one or more transport blocks (TBs), and/or where coded bits for at least one TB of the two or more TBs are mapped to a first set of spatial layers of a first subband of the multiple subbands and to a second set of spatial layers of a second subband of the multiple subbands. Other aspects relate to transmitting the assignment or DCI scheduling communications, and transmitting or receiving the communications over the multiple subbands.

### FIELD OF THE DISCLOSURE

Aspects of the present disclosure relate generally to wireless communication systems, and more particularly, to transmitting communications over multiple spatial layers.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to receive, from a network node, an assignment of multiple subbands associated with a virtual carrier for receiving or transmitting communications, and receive or transmit communications over the multiple subbands, where the communications include two or more transport blocks (TBs), and where coded bits for at least one TB of the two or more TBs are mapped to a first set of spatial layers of a first subband of the multiple subbands and to a second set of spatial layers of a second subband of the multiple subbands.

In another aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to transmit, to a UE, an assignment of multiple subbands associated with a virtual carrier for receiving or transmitting communications, and receive or transmit communications over the multiple subbands, where the communications include two or more TBs, and where coded bits for at least one TB of the two or more TBs are mapped to a first set of spatial layers of a first subband of the multiple subbands and to a second set of spatial layers of a second subband of the multiple subbands.

In another aspect, a method for wireless communication at a UE is provided that includes receiving, from a network node, an assignment of multiple subbands associated with a virtual carrier for receiving or transmitting communications, and receiving or transmitting communications over the multiple subbands, where the communications include two or more TBs, and where coded bits for at least one TB of the two or more TBs are mapped to a first set of spatial layers of a first subband of the multiple subbands and to a second set of spatial layers of a second subband of the multiple subbands.

In another aspect, a method for wireless communication at a network node is provided that includes transmitting, to a UE, an assignment of multiple subbands associated with a virtual carrier for receiving or transmitting communications, and receiving or transmitting communications over the multiple subbands, where the communications include two or more TBs, and where coded bits for at least one TB of the two or more TBs are mapped to a first set of spatial layers of a first subband of the multiple subbands and to a second set of spatial layers of a second subband of the multiple subbands.

In another aspect, a method for wireless communication at a UE is provided that includes receiving, from a network node, downlink control information (DCI) scheduling resources for receiving or transmitting communications over multiple subbands, and receiving or transmitting communications over the multiple subbands, where coded bits for a first number of TBs of the communications are mapped to a first set of spatial layers of a first subband of the multiple subbands, and where coded bits for a second number of TBs of the communications are mapped to a second set of spatial layers of a second subband of the multiple subbands.

In another aspect, a method for wireless communication at a network node is provided that includes transmitting, to a UE, DCI scheduling resources for receiving or transmitting communications over multiple subbands, and receiving or transmitting communications over the multiple subbands, where coded bits for a first number of TBs of the communications are mapped to a first set of spatial layers of a first subband of the multiple subbands, and where coded bits for a second number of TBs of the communications are mapped to a second set of spatial layers of a second subband of the multiple subbands.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for communicating with a UE based on mapping or demapping two or more transport blocks (TBs) to one or more spatial layers in multiple subbands, in accordance with aspects described herein;

FIG. 6 is a flow chart illustrating an example of a method for communicating with a network node (or another UE in sidelink communications) based on mapping or demapping two or more TBs to one or more spatial layers in multiple subbands, in accordance with aspects described herein;

FIG. 7 illustrates examples of TBs mapped to spatial layers of multiple subbands, in accordance with aspects described herein;

FIG. 8 is a flow chart illustrating an example of a method for communicating with a UE based on mapping or demapping one or more TBs to one or more spatial layers in multiple subbands, in accordance with aspects described herein;

FIG. 9 is a flow chart illustrating an example of a method for communicating with a network node (or another UE in sidelink communications) based on mapping or demapping one or more TBs to one or more spatial layers in multiple subbands, in accordance with aspects described herein; and

FIG. 10 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to communicating one or more transport blocks (TBs) over multiple spatial layers and/or multiple subbands (in frequency) in wireless communications. In wireless communication technologies, such as fifth generation (5G) new radio (NR) or other wireless communication technologies, devices (e.g., user equipment (UE) and/or base stations/gNBs, etc.) can communicate with one another using encoded communications where a device transmitting the communications can map a TB to one or more spatial layers (and/or a device receiving the communications can demap the TB from the one or more spatial layers) where each layer can correspond to one or more antenna elements of the device. For example, a device transmitting the communications can encode and rate match each TB to generate a corresponding codeword (CW), and can scramble and perform modulation for the CW to generate complex valued modulated symbols for each CW. The device can perform CW-layer mapping to map each CW to one or more spatial layers, and can perform precoding, mapping to resources to map the spatial layers to antenna elements for transmission. For example, a device receiving the communications can perform CW-layer demapping to demap the spatial layers to the complex valued modulated symbols, and then can perform demodulation on the symbols, descrambling, and decoding to generate the corresponding CW and/or TB. In an example, a network node (e.g., base station/gNB) can configure a UE with the number of layers to use for transmitting or receiving communications.

In 5G NR, for example, for communicating using up to four layers, a transmitting device can map (and/or a receiving device can demap) one TB (or CW) to all spatial layers. For more than 4 layers, two TBs (or CWs) can be mapped to different layers of one channel (e.g., physical downlink shared channel (PDSCH)). Each TB (or CW) can include one or multiple code blocks (CBs), and a transmitting device can perform encoding (and/or a receiving device can perform decoding) per CB. In an example, for the case of more than four spatial layers (e.g., ν>4, where ν can represent the number of spatial layers) configured in 5G NR, a transmitting device can map modulated symbols of a first CW (CW0),

$${M}_{s y m b}^{( 0 )}$$

modulated symbols, to the first [ν/2] layers and modulated symbols of a second CW (CW1),

$${M}_{s y m b}^{( 1 )}$$

modulated symbols, to the remaining [ν/2] layers. For example, for five layers, a transmitting device can map the modulated symbols of the first CW to first two layers and the modulated symbols of the second CW to the remaining three layers (2+3=5). Other CW-layer mapping approaches (such as 2 CWs even for 4 layers or smaller) may be used in other examples. In terms of signaling, downlink control information (DCI) scheduling PDSCH with two TBs can indicate two modulation and coding schemes (MCSs), two redundancy versions (RVs), two new data indicators (NDIs) for the two CWs while other parameters (time division resource allocation (TDRA), frequency division resource allocation (FDRA), hybrid automatic repeat/request (HARQ) identifier (ID), etc.) can be the same.

In the example described above for five spatial layers, given a large frequency allocation for the communication, the transmitting device can map (and/or the receiving device can demap) a first code block (CB1) and a second code block (CB2) of a first TB (TB0), or CW0, to different resource blocks (RBs) in one OFDM symbol in a first two spatial layers, and can map (or demap) a first CB (CB1), second CB (CB2), and third CB (CB3) of a second TB (TB1), or CW1, to different RBs in a next three spatial layers of the one OFDM symbol. In another example described above for five spatial layers, given a small frequency allocation for the communication, the transmitting device can map (and/or the receiving device can demap) a first code block (CB1) of a first TB (TB0), or CW0, in multiple (or all) OFDM symbols (in time) in a first two spatial layers, and can map (or demap) a first CB (CB1) of a second TB (TB1), or CW1), in multiple (or all) OFDM symbols (in time) in a next three spatial layers.

In another example, in 5G NR, carrier aggregation (CA) can be configured to combine multiple component carriers (CC) for communicating between devices. In another example, flexible spectrum integration (FSI), or other types of integration, can be used to unify physical (PHY) layer and/or media access control (MAC) layer across CCs. The FSI can be performed by integrating (otherwise referred to as combining) CCs (in the same or different frequency bands, referred to as subbands (SBs)) to form a single virtual CC, which can also be referred to as a virtual carrier. Moreover, in some contexts, a CC can be provided by or within, and sometimes referred to as, a cell. Thus, in some examples, the virtual CC formed by combining CCs in FSI can be referred to as a virtual cell. The virtual CC can be referred to as virtual as it is actually a collection of multiple physical CCs, but acts, or can be viewed, as a single CC for scheduling and/or HARQ. Thus, for example, a physical downlink control channel (PDCCH) can be used for scheduling across the multiple SBs of the virtual CC. If the PDCCH is restricted to be transmitted on one of the SBs, this can result in a smaller decoding attempts by an associated UE that receives the PDCCH, a narrow radio frequency (RF) for PDCCH than if the PDCCH was transmitted in all or multiple SBs (which can have power/area benefits), and/or unifying retransmissions across SBs for improved diversity. Integrating CCs can also provide different types of TB scheduling across aggregated SBs. In one example, small and scattered frequency division duplexing (FDD) channels can be integrated as one large virtual carrier, and a single TB can be scheduled over the virtual carrier (e.g., over all or multiple SBs of the virtual carrier). In another example, multiple TBs can be scheduled using a single PDCCH (which may be restricted to be transmitted on a single SB, as described above). Integrating CCs can also provide BW adaptation using bandwidth part (BWP) mechanisms that can be used for low latency adaptation depending on UE's RF BW and configured measurements.

As described, for example, FSI can be provided with single PDSCH scheduling/mapping (e.g., such that a single DCI transmitted on one of the multiple CCs or associated SBs, e.g., an anchor SB, schedules PDSCH resources on multiple SBs. In such examples, the transmitting node can map each TB to (and/or the receiving node can demap each TB from) a non-contiguous BWP that is activated within the virtual cell. In this example, single-CC PDCCH blind detection can be performed on the anchor SB, and TBs can be mapped across multiple SBs with a CB-level interleaving, such that each CB can be mapped to all/most SBs. This can be favorable in low-band spectrum with small channels. A TB spanning different SBs may be scheduled with different link parameters such modulation order, rank, etc.

In some examples, for FSI, a transmitting node can map (and/or a receiving node can demap) the coded bits of a given TB (or coded bits of each CB of the given TB) to multiple SBs or CCs to achieve frequency diversity. If a PDSCH or physical uplink shared channel (PUSCH) transmission (that spans multiple SBs or CCs) includes a single TB (or CW), the transmitting node can map (and/or the receiving node can demap) the coded bits as described above (e.g., even in the case of different SBs having different number of layers or different modulation orders). For example, mapping of coded bits of each CB to each resource element (RE) of a first SB or each RE of the second SB can depend on both number of layers and modulation order for that SB.

Aspects described herein relate to mapping (or demapping) one or more TBs to different sets of spatial layers of a given SB or CC (e.g., in CA or FSI). For example, aspects described herein can relate to using or determining a number of TBs to map (or demap) when different SBs have different number of spatial layers. For example, for a first PDSCH (PDSCH1) in a first CC (CC1) scheduled with rank three, and a second (PDSCH2) in a second CC (CC2) scheduled with rank five, the transmitting node can map (or the receiving node can demap) one or two TBs in one or more of the subbands based on the rank and/or other considerations. In addition, for example, aspects described herein relate to mapping the TBs (or CWs) using CW-layer mapping where different SBs can have a have different number of spatial layers, which can include selecting which TBs to map, selecting whether one or more TBs are mapped to one or both (or more) SBs, selecting across which sets of spatial layers of each SB to map the one or more TBs, etc.

In this regard, aspects described herein can facilitate mapping (or demapping) one or more TBs over multiple spatial layers in multiple subbands to achieve frequency diversity, optimize throughput, etc. in communications between devices in the wireless network. Thus can improve spectrum usage, resource allocation, device performance, user experience in using UEs, and/or the like.

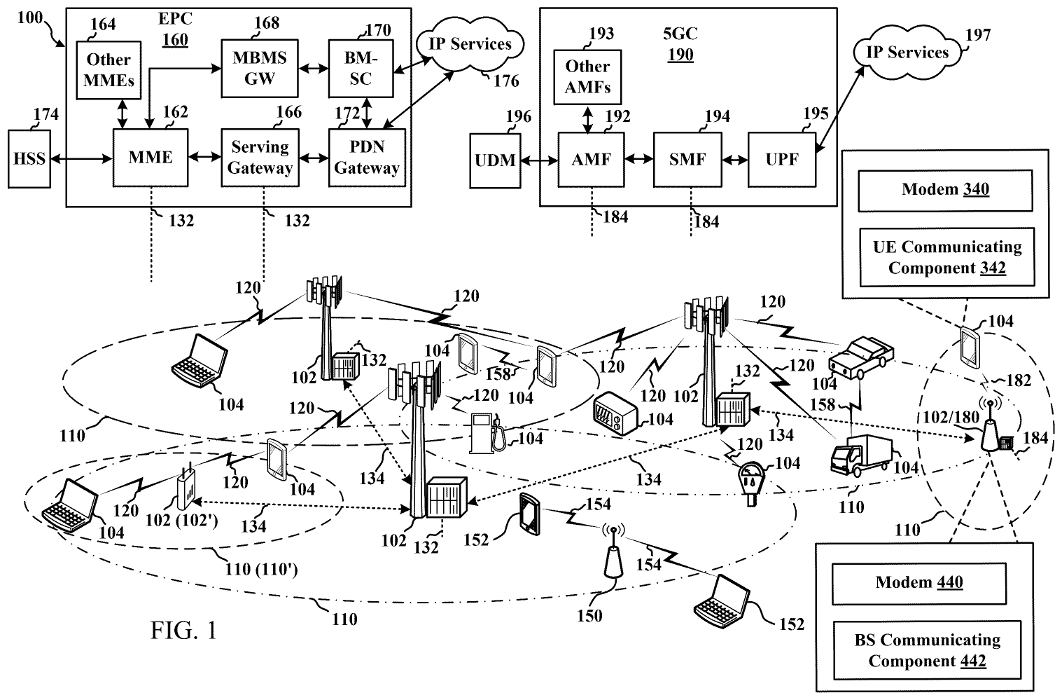

The described features will be presented in more detail below with reference to FIGS. 1-10.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for mapping or demapping one or more TBs to one or more spatial layers in multiple subbands, in accordance with aspects described herein. In addition, some nodes may have a modem 440 and BS communicating component 442 for mapping or demapping, or configuring a UE for mapping or demapping, one or more TBs to one or more spatial layers in multiple subbands, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, BS communicating component 442 of a base station 102/gNB 180 can map one or more TBs over one or more spatial layer in multiple subbands for transmitting communications to a UE 104. In this example, UE communicating component 342 of a UE 104 can receive the communications from the base station 102/gNB 180 and can demap the one or more TBs from the one or more spatial layers in the multiple subbands. In another example, UE communicating component 342 of a UE 104 can map one or more TBs over one or more spatial layer in multiple subbands for transmitting communications to a base station 102/gNB 180. In this example, BS communicating component 442 of a base station 102/gNB 180 can receive the communications from the UE 104 and can demap the one or more TBs from the one or more spatial layers in the multiple subbands. In an example, base station 102/gNB 180 can configure the UE 104 for mapping or demapping the one or more TBs in this regard.

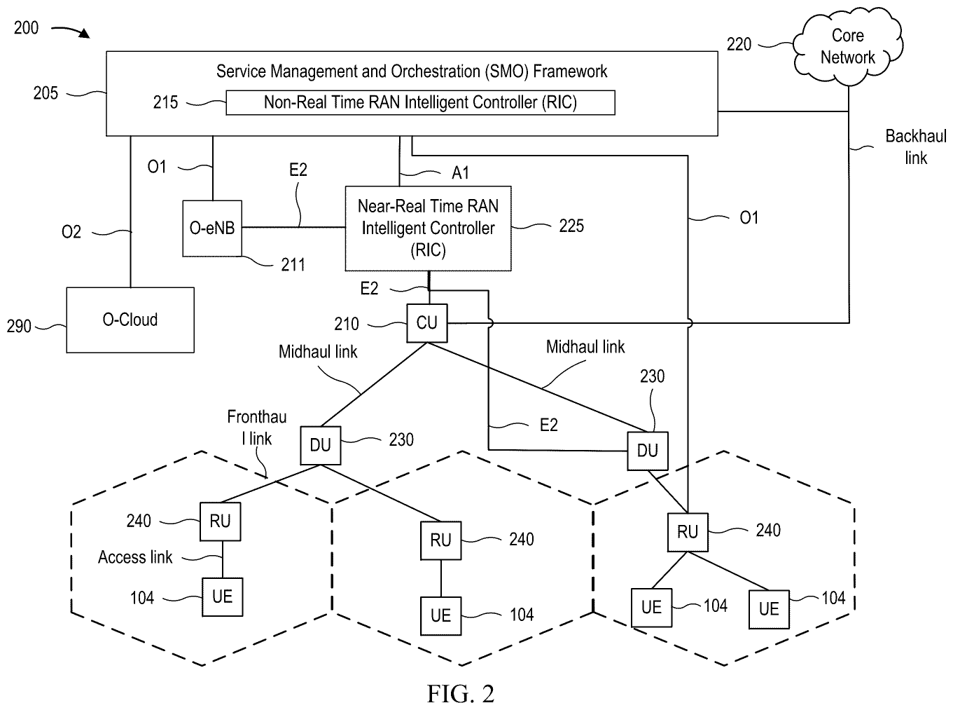

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

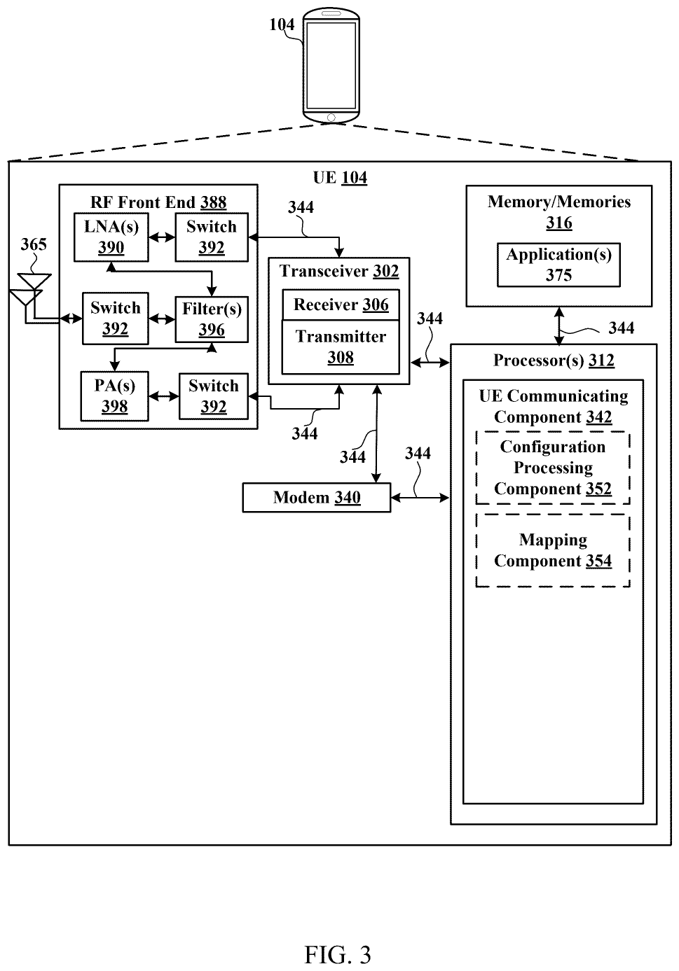

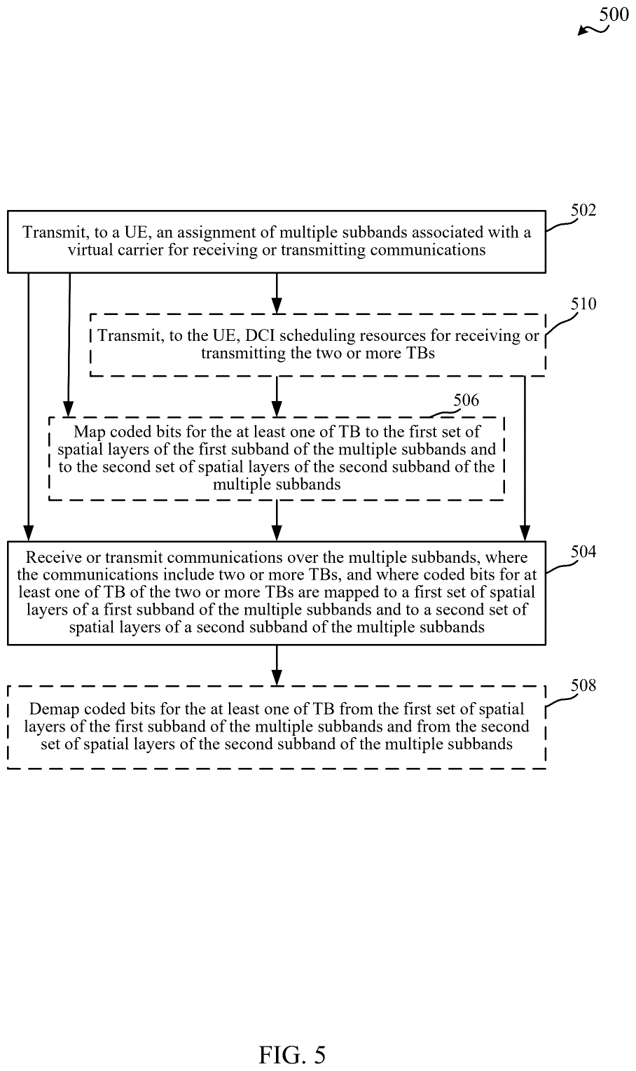

Turning now to FIGS. 3-10, aspects are depicted with reference to one or more components and one or more methods that may perform the actions or operations described herein, where aspects in dashed line may be optional. Although the operations described below in FIGS. 5, 6, 8, and 9 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for mapping or demapping one or more TBs to one or more spatial layers in multiple subbands, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312. Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a configuration processing component 352 for processing a configuration received from a network node (e.g., a base station 102/gNB 180) for determining multiple subbands associated with a virtual carrier (e.g., when a virtual carrier is configured using CA or FSI), and/or a mapping component 354 for mapping or demapping one or more TBs to one or more spatial layers of the multiple subbands, in accordance with aspects described herein.

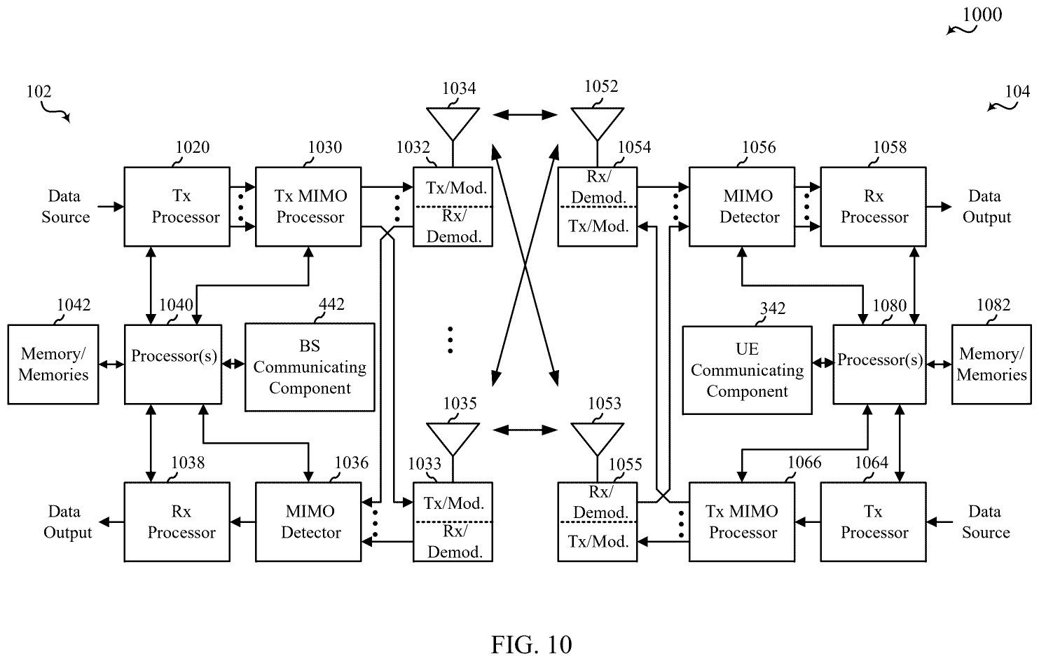

In an aspect, the processor(s) 312 may correspond to one or more of the processors described in connection with the UE in FIG. 10. Similarly, the memory/memories 316 may correspond to the one or more memories described in connection with the UE in FIG. 10.

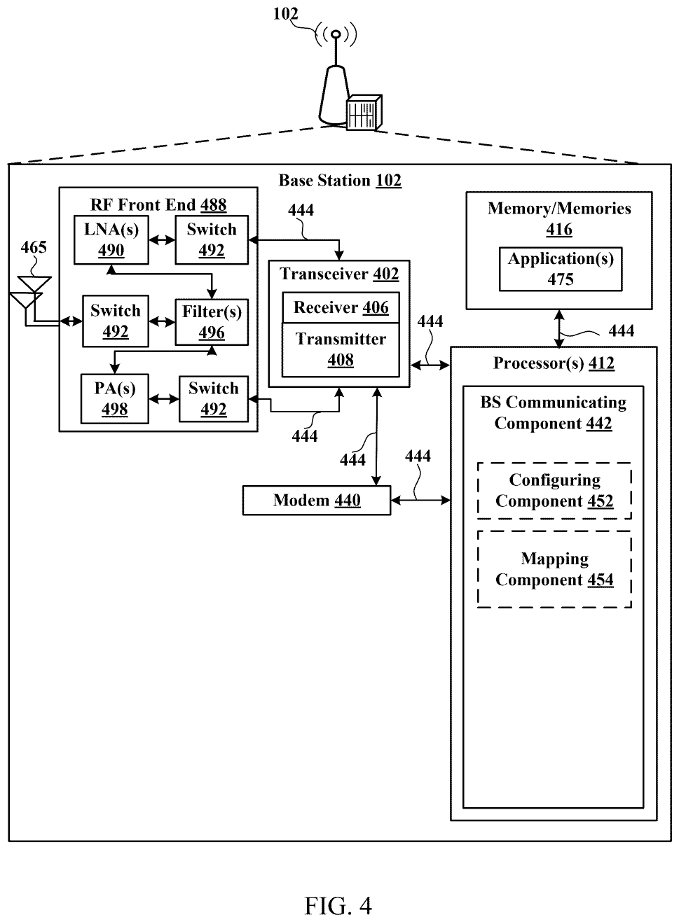

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or BS communicating component 442 for mapping or demapping, or configuring a UE for mapping or demapping, one or more TBs to one or more spatial layers in multiple subbands, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a configuring component 452 for configuring a UE 104 for determining multiple subbands associated with a virtual carrier (e.g., when a virtual carrier is configured using CA or FSI), and/or a mapping component 354 for mapping or demapping one or more TBs to one or more spatial layers of the multiple subbands, in accordance with aspects described herein.

In an aspect, the processor(s) 412 may correspond to one or more of the processors described in connection with the base station in FIG. 10. Similarly, the memory/memories 416 may correspond to the one or more memories described in connection with the base station in FIG. 10.

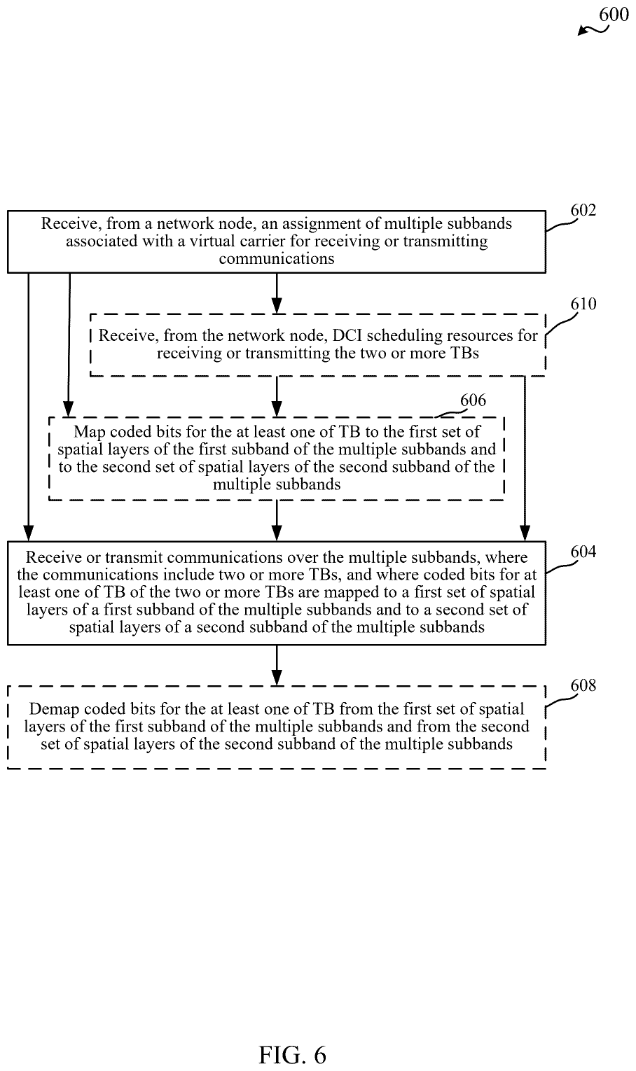

FIG. 5 illustrates a flow chart of an example of a method 500 for communicating with a UE based on mapping or demapping two or more TBs to one or more spatial layers in multiple subbands, in accordance with aspects described herein. FIG. 6 illustrates a flow chart of an example of a method 600 for communicating with a network node (or another UE in sidelink communications) based on mapping or demapping two or more TBs to one or more spatial layers in multiple subbands, in accordance with aspects described herein. In an example, a base station 102 or gNB 180, a monolithic base station or gNB, a portion of a disaggregated base station or gNB, a UE in sidelink communication, etc., can perform the functions described in method 500 shown in FIG. 5 using one or more of the components described in FIGS. 1 and/or 4. In an example, a UE 104 can perform the functions described in method 600 shown in FIG. 6 using one or more of the components described in FIGS. 1 and/or 3. In addition, methods 500 and 600 are described in conjunction with one another for ease of explanation; however, the methods 500 and 600 are not required to be performed together and indeed can be performed independently using separate devices.

In method 500, at Block 502, an assignment of multiple subbands associated with a virtual carrier for receiving or transmitting communications can be transmitted to a UE. In an aspect, configuring component 452, e.g., in conjunction with processor(s) 412, memory/memories 416, transceiver 402, BS communicating component 442, etc., can transmit, to the UE (e.g., UE 104), the assignment of multiple subbands associated with the virtual carrier for receiving or transmitting communications. For example, configuring component 452 can configure the UE 104 to communicate over multiple component carriers (CCs) or multiple corresponding subbands (e.g., concurrently) as one virtual carrier in CA or FSI. In an example, configuring component 452 can transmit the configuration for the UE 104 using radio resource control (RRC) layer signaling, MAC-control element (CE), DCI, and/or the like.

In method 500, at Block 504, communications can be received or transmitted over the multiple subbands, where the communications include two or more TBs, and where coded bits for at least one TB of the two or more TBs are mapped to a first set of spatial layers of a first subband of the multiple subbands and to a second set of spatial layers of a second subband of the multiple subbands. In an aspect, BS communicating component 442, e.g., in conjunction with processor(s) 412, memory/memories 416, transceiver 402, etc., can receive the communications, or transmit the communications, over the multiple subbands, where the communications include two or more TBs, and where coded bits for at least one TB of the two or more TBs are mapped to the first set of spatial layers of the first subband of the multiple subbands and to the second set of spatial layers of the second subband of the multiple subbands.

For example, where communications are transmitted (and not received) at Block 504, optionally at Block 506, the coded bits for the at least one TB can be mapped to the first set of spatial layers of the first subband of the multiple subbands and to the second set of spatial layers of the second subband of the multiple subbands. In an aspect, mapping component 454, e.g., in conjunction with processor(s) 412, memory/memories 416, transceiver 402, BS communicating component 442, etc., can map the coded bits for the at least one TB to the first set of spatial layers of the first subband of the multiple subbands and to the second set of spatial layers of the second subband of the multiple subbands. For example, mapping component 454 can map the coded bits for a given TB to multiple spatial layers at least in part by mapping a portion of coded bits for the TB to each of the multiple spatial layers (e.g., mapping a first portion of the coded bits to a first spatial layer, a second portion of the coded bits to a second spatial layer, etc.). Various aspects of mapping the at least one TB are described herein.

For example, where communications are received (e.g., from a UE and thus Block 506 is not applicable) at Block 504, optionally at Block 508, the coded bits for the at least one TB can be demapped from the first set of spatial layers of the first subband of the multiple subbands and from the second set of spatial layers of the second subband of the multiple subbands. In an aspect, mapping component 454, e.g., in conjunction with processor(s) 412, memory/memories 416, transceiver 402, BS communicating component 442, etc., can demap the coded bits for the at least one TB from the first set of spatial layers of the first subband of the multiple subbands and from the second set of spatial layers of the second subband of the multiple subbands. For example, mapping component 454 can demap the coded bits for a given TB from multiple spatial layers at least in part by demapping a portion of coded bits for the TB from each of the multiple spatial layers (e.g., demapping a first portion of the coded bits from a first spatial layer, a second portion of the coded bits from a second spatial layer, etc.). Various aspects of demapping the at least one TB are described herein. In particular, though concepts are described herein in terms of mapping, the concepts can be similarly applied for demapping the at least one TB from one or more spatial layers in multiple subbands.

In method 600, at Block 602, an assignment of multiple subbands associated with a virtual carrier for receiving or transmitting communications can be received from a network node. In an aspect, configuration processing component 352, e.g., in conjunction with processor(s) 312, memory/memories 316, transceiver 302, UE communicating component 342, etc., can receive and/or process, from a network node, the assignment of multiple subbands associated with the virtual carrier for receiving or transmitting communications. For example, configuration processing component 352 can receive the assignment using RRC layer signaling, MAC-CE, DCI, and/or the like. In an example, the assignment can enable the UE to concurrently communicate over multiple subbands as one virtual carrier in CA or FSI.

For example, in method 600, at Block 604, communications can be received or transmitted over the multiple subbands, where the communications include two or more TBs, and where coded bits for at least one TB of the two or more TBs are mapped to a first set of spatial layers of a first subband of the multiple subbands and to a second set of spatial layers of a second subband of the multiple subbands. In an aspect, UE communicating component 342, e.g., in conjunction with processor(s) 312, memory/memories 316, transceiver 302, etc., can receive the communications, or transmit the communications, over the multiple subbands, where the communications include two or more TBs, and where coded bits for at least one TB of the two or more TBs are mapped to the first set of spatial layers of the first subband of the multiple subbands and to the second set of spatial layers of the second subband of the multiple subbands.

For example, where communications are transmitted (and not received) at Block 604, optionally at Block 606, the coded bits for the at least one TB can be mapped to the first set of spatial layers of the first subband of the multiple subbands and to the second set of spatial layers of the second subband of the multiple subbands. In an aspect, mapping component 354, e.g., in conjunction with processor(s) 312, memory/memories 316, transceiver 302, UE communicating component 342, etc., can map the coded bits for the at least one TB to the first set of spatial layers of the first subband of the multiple subbands and to the second set of spatial layers of the second subband of the multiple subbands. For example, mapping component 454 can map the coded bits for a given TB to multiple spatial layers at least in part by mapping a portion of coded bits for the TB to each of the multiple spatial layers (e.g., mapping a first portion of the coded bits to a first spatial layer, a second portion of the coded bits to a second spatial layer, etc.). Various aspects of mapping the at least one TB are described herein.

For example, where communications are received (e.g., from a network node, and thus Block 606 is not applicable) at Block 604, optionally at Block 608, the coded bits for the at least one TB can be demapped from the first set of spatial layers of the first subband of the multiple subbands and from the second set of spatial layers of the second subband of the multiple subbands. In an aspect, mapping component 354, e.g., in conjunction with processor(s) 312, memory/memories 316, transceiver 302, UE communicating component 342, etc., can demap the coded bits for the at least one TB from the first set of spatial layers of the first subband of the multiple subbands and from the second set of spatial layers of the second subband of the multiple subbands. For example, mapping component 454 can demap the coded bits for a given TB from multiple spatial layers at least in part by demapping a portion of coded bits for the TB from each of the multiple spatial layers (e.g., demapping a first portion of the coded bits from a first spatial layer, a second portion of the coded bits from a second spatial layer, etc.). Various aspects of demapping the at least one TB are described herein. In particular, though concepts are described herein in terms of mapping, the concepts can be similarly applied for demapping the at least one TB from one or more spatial layers in multiple subbands.

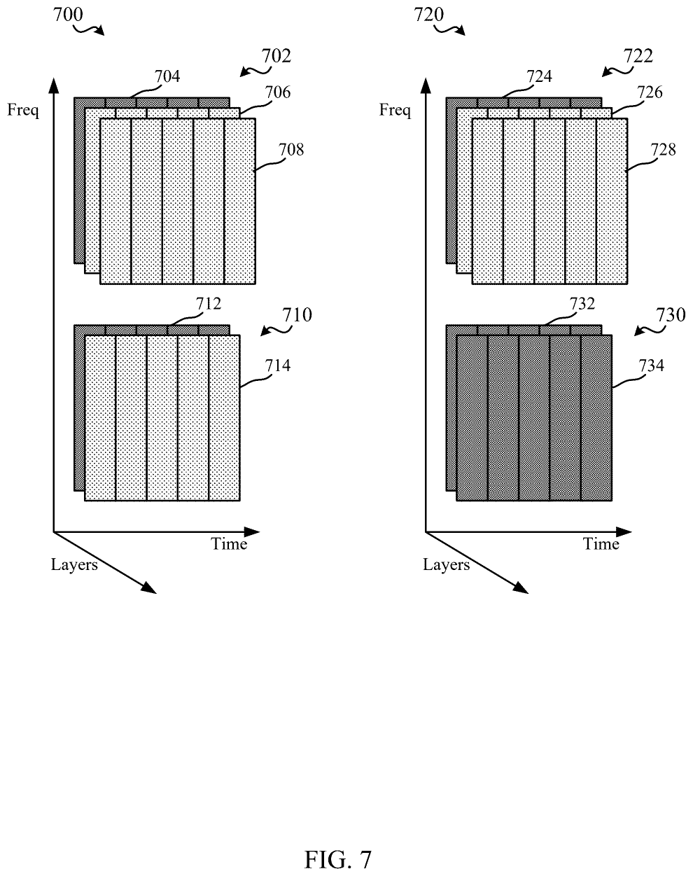

For example, communications between a UE 104 and base station 102/gNB 180 (e.g., PDSCH transmitted by a base station 102/gNB 180 and received by a UE, or PUSCH transmitted by a UE 104 and received by a base station 102/gNB 180) can span multiple subbands, such as SB1 and SB2, in CA or FSI and can have multiple TBs. In this example, mapping component 354 or 454 of the transmitting node can map (and/or mapping component 454 or 354 the receiving node can demap) coded bits of at least one of the TBs to (or from) both SB1 and SB2. In one example, mapping component 354 or 454 can map (or demap) coded bits of each of the multiple TBs (e.g., or at least two or more of the TBs), and/or coded bits of each CB of each of the multiple TBs, to both SB1 and SB2 (or additional multiple SBs). For instance, a first TB (TB1) can be mapped to (or demapped from) a first set of spatial layers of SB1 and a second set of spatial layers of SB2, and/or a second TB (TB2) can be mapped to (or demapped from) a third set of spatial layers of SB1 and a fourth set of spatial layers of SB2. In another example, mapping component 354 or 454 can map (or demap) coded bits of the first TB (TB1), or corresponding CBs, to both SB1 and SB2, and/or coded bits of the second TB (TB2), or corresponding CBs, to only one SB (e.g., only to SB1). For instance, a first TB (TB1) can be mapped to a first set of layers of SB1 and all layers of SB2, and/or a second TB (TB2) can be mapped to a second set of layers of SB1. Various examples are shown in FIG. 7.

FIG. 7 illustrates examples 700 and 720 of TBs mapped to spatial layers of multiple SBs, in accordance with aspects described herein. Examples 700 and 720 can correspond to a specific example where a number of spatial layers of a first subband ν₁=3, and a number of spatial layers of a second subband ν₂=2. In accordance with one example, described above, in example 700, each of TB1 and TB2 can be mapped to both SB1 and SB2 (shown as TB1 704 mapped to SB1 702, TB1 712 mapped to SB2 710, TB2 706 and 708 mapped to SB1 702, and TB2 714 mapped to SB2 710). In this example, frequency diversity can be improved as each TB goes through both SBs. On the other hand, when number of layers of a given SB is small, the layers of that SB may not split to multiple sets to be mapped to different TBs. In accordance with another example, described above, TB1 can be mapped to both SB1 and SB2, while TB2 can be mapped only to SB1 (shown as TB1 724 mapped to SB1 722, TB1 732 and 734 mapped to SB2 730, and TB2 726 and 728 mapped to SB1 722). When two TBs are mapped to at least one SB (e.g., SB1), aspects described herein relate to mapping component 354 or 454 selecting or determining whether both TBs or only one of the two TBs should be mapped to (or demapped from) other SBs (e.g., SB2).

For example, mapping component 354 or 454 can map (or demap) multiple (e.g., both of two) TBs to a given SB or only one of the multiple TBs to the given SBs based on a number of spatial layers of the given SB. In one example, if the number of spatial layers of the given SB is greater than or equal to a threshold (e.g., more than one in one example, or more than four in another example), mapping component 354 or 454 can map (or demap) both TBs to this SB; otherwise, mapping component 354 or 454 can map (or demap) only one of the TBs to this SB. In one example, the threshold can be configured for the UE 104 and/or base station 102/gNB 180 using signaling, or can be stored in a memory of the UE 104 and/or base station 102/gNB 180 based on a wireless communication technology standard, such as 5G NR.

In addition to number of layers of the given SB, for example, other factors may be also considered in other examples, such as difference between number of layers of other SBs and number of layers of the given SB. For example, if number of layers of the given SB is one, then mapping component 354 or 454 can map (or demap) only one of the TBs to this SB (e.g., which may be the only choice). If, however, number of layers of the given SB is two or more, mapping component 354 or 454 can map (or demap) both TBs to the given SB if the difference between maximum number of layers across SBs and number of layers of the given SB is smaller than a threshold; otherwise, mapping component 354 or 454 can map (or demap) only one of the TBs to the given SB. This can result in mapping the TBs over multiple SBs in many cases (e.g., to achieve the frequency diversity for the TBs) unless mapping is not feasible (e.g., for rank 1 communications) or when rank imbalance across SBs is too large. For example, considering SB2 and the threshold on the difference above is three: If (ν₁, ν₂)=(4,4) or (4,3) or (4,2) or (5,3) (e.g., difference between number of spatial layers across the SBs is two or less), mapping component 354 or 454 can map (or demap) both TBs to SB2. If (ν₁, ν₂)=(5,2) (e.g., difference between number of spatial layers across the SBs is three), mapping component 354 or 454 can map (or demap) only one TB to SB2. If ν₂=1, mapping component 354 or 454 can map (or demap) only one TB to SB2 (e.g., which may be the only choice).

In another example, mapping component 354 or 454 can map (or demap) multiple (e.g., both of two) TBs to a given SB or only one of the multiple TBs to the given SBs based on an explicit indication from the network. For example, configuring component 452 can configure the UE 104 with the indication (e.g., in RRC signaling, MAC-CE, etc., which can be part of the assignment received in Block 602 or otherwise, via the scheduling DCI—e.g., DCI that schedules this PDSCH/PUSCH can also indicate for each SB, which of the two TBs or both TBs are mapped to this SB, etc.). For example, in method 500, optionally at Block 510, DCI scheduling resources for receiving or transmitting the two or more TBs can be transmitted to the UE. In an aspect, configuring component 452, e.g., in conjunction with processor(s) 412, memory/memories 416, transceiver 402, BS communicating component 442, etc., can transmit, to the UE, DCI scheduling resources for receiving or transmitting the two or more TBs. As described, in one example, the DCI can include an indication to map (or demap) multiple (e.g., both of two) TBs to a given SB or only one of the multiple TBs to the given SBs, and mapping component 454 can accordingly map (or demap) the multiple TBs from one or more SBs based on the indication. In addition, in an example, in method 600, optionally at Block 610, DCI scheduling resources for receiving or transmitting the two or more TBs can be received from the network node. In an aspect, configuration processing component 352, e.g., in conjunction with processor(s) 312, memory/memories 316, transceiver 302, UE communicating component 342, etc., can receive, from the network node, DCI scheduling resources for receiving or transmitting the two or more TBs. As described, in one example, the DCI can include an indication to map (or demap) multiple (e.g., both of two) TBs to a given SB or only one of the multiple TBs to the given SBs, and mapping component 354 can accordingly map (or demap) the multiple TBs to one or more SBs based on the indication.

In an example, where both (or multiple) TBs are mapped to a given SB, as described above, mapping component 354 or 454 can divide the spatial layers of this SB to a first set of spatial layers and a second set of spatial layers such that at least one of the TBs, TB1, is mapped to the first set of spatial layers and at least another one of the TBs, TB2, is mapped to the second set of spatial layers. In one example, for a given SB (included in the PDSCH or PUSCH) with ν layers to which both TB1 and TB2 are mapped, mapping component 354 or 454 can determine a first set of spatial layers to which to map (or demap) TB1 and a second set of spatial layers to which to map (or demap) TB2 such that TB1 is mapped to the first [ν/2] layers and TB2 is mapped to the remaining [ν/2] layers. For example, given (ν₁, ν₂)=(5,3), mapping component 354 or 454 can map (or demap) TB1 to the first two spatial layers of SB1 and to the first spatial layer of SB2, and can map (or demap) TB2 to the next three spatial layers of SB1 and to the next two spatial layers of SB2.

In another example, where both (or multiple) TBs are mapped to a given SB, as described above, mapping component 354 or 454 can divide the spatial layers of this SB to a first set of spatial layers and a second set of spatial layers such that the number of spatial layers in the respective sets are based on other factors, such as a SB index of one or more of the SBs, a number of spatial layers of other SBs, and/or the like. In this regard, for example, mapping component 354 or 454 can attempt to balance the number of spatial layers mapped to TB1 and TB2 across SBs. For example, the SB index can refer to an order by which the SBs are configured for the UE (e.g., in the assignment of multiple subbands received at Block 602) and/or an index of the SBs indicated in the configuration. In an example, The SB index can be with respect to all SBs included in the PDSCH or PUSCH or may be based on reindexing SBs among those that have both TBs (e.g., without considering the SBs with a single TB). In one example, if SB index is odd, TB1 can be mapped to the first [ν/2] layers and TB2 can be mapped to the remaining [ν/2] layers. If SB index is even, TB1 can be mapped to the first [ν/2] layers and TB2 can be mapped to the remaining [ν/2] layers. In a specific example, where (ν₁, ν₂)=(5,3), mapping component 354 or 454 can map (or demap) TB1 to first two spatial layers of SB1 and to the first two spatial layers of SB2, and/or TB2 can be mapped to the next three spatial layers of SB1 and to the last spatial layer of SB2.

In another example, mapping component 354 or 454 can calculate a reference number of layers, vref, as a function of number of spatial layers across all SBs. Then, for a given SB with ν layers, mapping component 354 or 454 can map (or demap) TB1 to the first [ν_{ref}/2] layers and can map (or demap) TB2 to the remaining ν−[Vref/2] layers. For example, Vref can be equal to a maximum, minimum, or average number of layers across all SBs. In an example, in this regard, mapping component 354 or 454 can map (or demap) TB1 to the same number of layers across SBs (but the same may not be not true for TB2). In a specific example, where (ν₁, ν₂)=(5,3) and ν_{ref}=5 (max), mapping component 354 or 454 can map (or demap) TB1 to the first two spatial layers of SB1 and to the first two spatial layers of SB2, and can map (or demap) TB2 to the next three spatial layers of SB1 and to the last spatial layer of SB2.

In an example, where one or more SBs have a single TB mapped, for TB1 and TB2 that are mapped to the first νₓ layers and remaining ν−νₓ layers of the given SB, where ν layers is the number of layers of the given SB. In this case, νₓ or ν−νₓ can be a function of number of layers assigned to each of the TB1 and TB2 across other SBs (e.g., ν_{A} layers for TB1 across other SBs, ν_{B} layers for TB2 across other SBs). For example, to balance number of layers including a given SB, νₓ=[(ν+ν_{B}−ν_{A})/2]. The other SBs considered above (e.g., to calculate ν_{A} and ν_{B}) can be those to which mapping component 354 or 454 can map (or demap) a single TB, or can be all SBs with assigned TBs (e.g., before this given SB) and corresponding number of layers (in the latter case, an order across the SBs can be used for assignment, e.g., based on SB index).

In another example, mapping component 354 or 454 can map (or demap) multiple (e.g., both of two) a first TB to a first set of layers and a second TB to a second set of layers based on an explicit indication from the network. For example, configuring component 452 can configure the UE 104 with the indication (e.g., in RRC signaling, MAC-CE, etc., which can be part of the assignment received in Block 602 or otherwise, via the scheduling DCI—e.g., DCI that schedules this PDSCH/PUSCH can also indicate for each SB, which of the two TBs or both TBs are mapped to this SB, etc.). The indication can indicate, for each SB, the first and second sets of layers (or the number of layers in the first/second sets) associated with TB1 and TB2, respectively. For example, mapping component 354 can accordingly map (or demap) the multiple TBs to one or more SBs based on the indication.

In yet another example, where mapping component 354 or 454 can map (or demap) only one TB to a given SB of the multiple SBs, mapping component 354 or 454 can determine which TB to map based on one or more considerations. For example, mapping component 354 or 454 can map the single TB that is the first (or the second) TB to the given SB, where the first TB may be the one associated with the first MCS or RV field of the scheduling DCI. In another example, mapping component 354 or 454 can map the single TB that is the first TB if the SB index is odd or the second TB if the SB index is even. In another example, mapping component 354 or 454 can map different SBs (with single TB) to different TBs to achieve a level of balancing across the two TBs. In another example, mapping component 354 or 454 can map the single TB that is the TB with higher (or lower) MCS value to the given SB. In another example, mapping component 354 or 454 can map the single TB based on an explicit indication from the network (e.g., in RRC, MAC-CE, scheduling DCI, etc.).

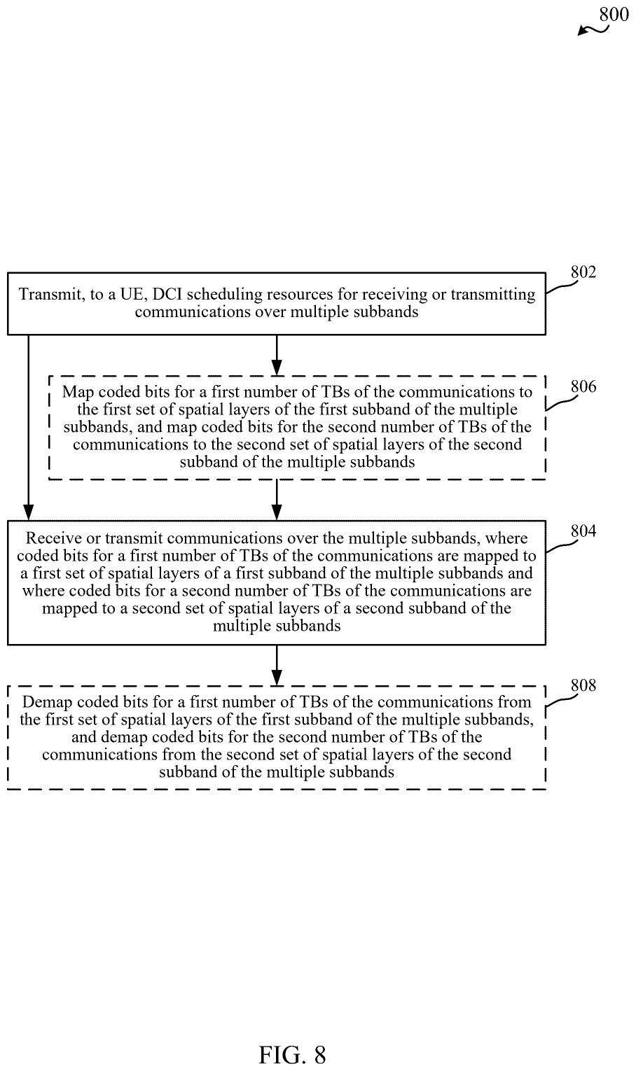

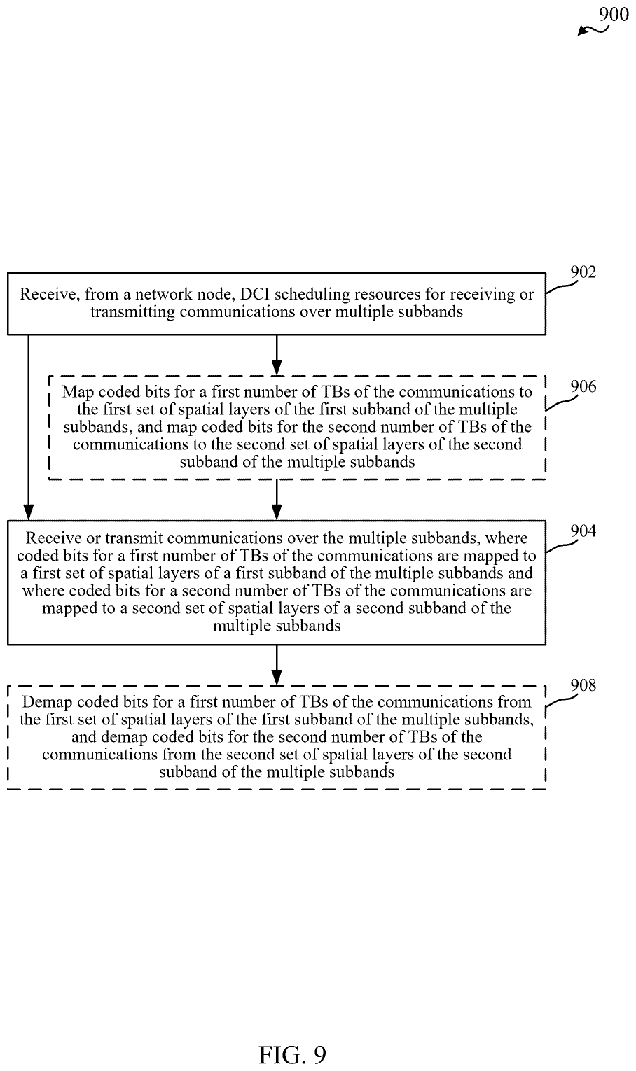

FIG. 8 illustrates a flow chart of an example of a method 800 for communicating with a UE based on mapping or demapping one or more TBs to one or more spatial layers in multiple subbands, in accordance with aspects described herein. FIG. 9 illustrates a flow chart of an example of a method 900 for communicating with a network node (or another UE in sidelink communications) based on mapping or demapping one or more TBs to one or more spatial layers in multiple subbands, in accordance with aspects described herein. In an example, a base station 102 or gNB 180, a monolithic base station or gNB, a portion of a disaggregated base station or gNB, a UE in sidelink communication, etc., can perform the functions described in method 800 shown in FIG. 8 using one or more of the components described in FIGS. 1 and/or 4. In an example, a UE 104 can perform the functions described in method 900 shown in FIG. 9 using one or more of the components described in FIGS. 1 and/or 3. In addition, methods 800 and 900 are described in conjunction with one another for ease of explanation; however, the methods 800 and 900 are not required to be performed together and indeed can be performed independently using separate devices.

In method 800, at Block 802, DCI scheduling resources for receiving or transmitting communications over multiple subbands can be transmitted to a UE. In an aspect, configuring component 452, e.g., in conjunction with processor(s) 412, memory/memories 416, transceiver 402, BS communicating component 442, etc., can transmit, to the UE (e.g., UE 104), DCI scheduling resources for receiving or transmitting communications over multiple subbands. For example, configuring component 452 can transmit a scheduling DCI to the UE 104 that indicates resources across two or more SBs for receiving PDSCH transmissions or transmitting PUSCH (e.g., in CA or FSI), and/or a number of layers for each SB (e.g., ν₁ layers for SB1 and ν₂ layers for SB2).

In method 900, at Block 902, DCI scheduling resources for receiving or transmitting communications over multiple subbands can be received from a network node. In an aspect, configuration processing component 352, e.g., in conjunction with processor(s) 312, memory/memories 316, transceiver 302, UE communicating component 342, etc., can receive and/or process, from a network node, DCI scheduling resources for receiving or transmitting communications over multiple subbands. In an example, DCI can enable the UE to concurrently communicate over multiple subbands as one virtual carrier in CA or FSI based on mapping one or more TBs to one or more spatial layers (e.g., ν₁ layers) in a first subband (SB1) and one or more spatial layers (e.g., ν₂ layers) in a second subband (SB2).

In method 800, at Block 804, communications can be received or transmitted over the multiple subbands, where coded bits for a first number of TBs of the communications are mapped to a first set of spatial layers of a first subband of the multiple subbands and where coded bits for a second number of TBs of the communications are mapped to a second set of spatial layers of a second subband of the multiple subbands. In an aspect, BS communicating component 442, e.g., in conjunction with processor(s) 412, memory/memories 416, transceiver 402, etc., can receive or transmit communications over the multiple subbands, where coded bits for the first number of TBs of the communications are mapped to the first set of spatial layers of the first subband of the multiple subbands and where coded bits for the second number of TBs of the communications are mapped to the second set of spatial layers of the second subband of the multiple subbands.

For example, where communications are transmitted at Block 804, optionally at Block 806, the coded bits for the first number of TBs of the communications can be mapped to the first set of spatial layers of the first subband of the multiple subbands and coded bits for the second number of TBs of the communications can be mapped to the second set of spatial layers of the second subband of the multiple subbands. In an aspect, mapping component 454, e.g., in conjunction with processor(s) 412, memory/memories 416, transceiver 402, BS communicating component 442, etc., can map the coded bits for the first number of TBs of the communications to the first set of spatial layers of the first subband of the multiple subbands and can map the coded bits for the second number of TBs of the communications to the second set of spatial layers of the second subband of the multiple subbands. Various aspects of mapping the first number of TBs and the second number of TBs are described herein.

For example, where communications are received at Block 804, optionally at Block 808, the coded bits for the first number of TBs of the communications can be demapped from the first set of spatial layers of the first subband of the multiple subbands and coded bits for the second number of TBs of the communications can be demapped from the second set of spatial layers of the second subband of the multiple subbands. In an aspect, mapping component 454, e.g., in conjunction with processor(s) 412, memory/memories 416, transceiver 402, BS communicating component 442, etc., can demap the coded bits for the first number of TBs of the communications from the first set of spatial layers of the first subband of the multiple subbands and can demap the coded bits for the second number of TBs of the communications from the second set of spatial layers of the second subband of the multiple subbands. Various aspects of demapping the first number of TBs and the second number of TBs are described herein. In particular, though concepts are described herein in terms of mapping, the concepts can be similarly applied for demapping the first number of TBs and the second number of TBs from the sets of spatial layers in multiple subbands.

Similarly, for example, in method 900, at Block 904, communications can be received or transmitted over the multiple subbands, where coded bits for a first number of TBs of the communications are mapped to a first set of spatial layers of a first subband of the multiple subbands and where coded bits for a second number of TBs of the communications are mapped to a second set of spatial layers of a second subband of the multiple subbands. In an aspect, UE communicating component 342, e.g., in conjunction with processor(s) 312, memory/memories 316, transceiver 302, etc., can receive or transmit communications over the multiple subbands, where coded bits for the first number of TBs of the communications are mapped to the first set of spatial layers of the first subband of the multiple subbands and where coded bits for the second number of TBs of the communications are mapped to the second set of spatial layers of the second subband of the multiple subbands.

For example, where communications are transmitted at Block 904, optionally at Block 906, the coded bits for the first number of TBs of the communications can be mapped to the first set of spatial layers of the first subband of the multiple subbands and coded bits for the second number of TBs of the communications can be mapped to the second set of spatial layers of the second subband of the multiple subbands. In an aspect, mapping component 354, e.g., in conjunction with processor(s) 312, memory/memories 316, transceiver 302, UE communicating component 342, etc., can map the coded bits for the first number of TBs of the communications to the first set of spatial layers of the first subband of the multiple subbands and can map the coded bits for the second number of TBs of the communications to the second set of spatial layers of the second subband of the multiple subbands. Various aspects of mapping the first number of TBs and the second number of TBs are described herein.

For example, where communications are received at Block 904, optionally at Block 908, the coded bits for the first number of TBs of the communications can be demapped from the first set of spatial layers of the first subband of the multiple subbands and coded bits for the second number of TBs of the communications can be demapped from the second set of spatial layers of the second subband of the multiple subbands. In an aspect, mapping component 354, e.g., in conjunction with processor(s) 312, memory/memories 316, transceiver 302, UE communicating component 342, etc., can demap the coded bits for the first number of TBs of the communications from the first set of spatial layers of the first subband of the multiple subbands and can demap the coded bits for the second number of TBs of the communications from the second set of spatial layers of the second subband of the multiple subbands. Various aspects of demapping the first number of TBs and the second number of TBs are described herein. In particular, though concepts are described herein in terms of mapping, the concepts can be similarly applied for demapping the first number of TBs and the second number of TBs from the sets of spatial layers in multiple subbands.

In accordance with various aspects, the number of TBs to map (e.g., the number of TBs of the PDSCH or PUSCH) can depend on a number of spatial layers of the first subband (SB1), ν₁, and a number of spatial layers of the first subband (SB2), ν₂. In one example, mapping component 354 or 454 can map (or demap) the number of TBs based on a maximum value of the number of layers for each subband, e.g., based on max(ν₁, ν₂). For example, if max(ν₁, ν₂) is greater than or equal to a threshold, mapping component 354 or 454 can map (or demap) two TBs; otherwise, mapping component 354 or 454 can map (or demap) one TB. In this regard, for example, if at least one SB can support larger number of TBs, the FSI PDSCH/can support the larger number of TBs. In another example, mapping component 354 or 454 can map (or demap) the number of TBs based on a minimum value of the number of layers for each subband, e.g., based on min(ν₁, ν₂). For example, if min(ν₁, ν₂) is greater than or equal to a threshold, mapping component 354 or 454 can map (or demap) two TBs; otherwise, mapping component 354 or 454 can map (or demap) one TB. In this regard, for example, if all SBs can support at least a given number of TBs, the FSI PDSCH/PUSCH can support the same number of TBs. In another example, mapping component 354 or 454 can map (or demap) the number of TBs based on an average value of the number of layers for each subband, e.g., based on avg(ν₁, ν₂). For example, if avg(ν₁, ν₂) is greater than or equal to a threshold, mapping component 354 or 454 can map (or demap) two TBs; otherwise, mapping component 354 or 454 can map (or demap) one TB. In this regard, for example, a balance between other examples explained above may be achieved.

In yet another example, mapping component 354 or 454 can map (or demap) the number of TBs based on a sum of values of the number of layers for each subband, e.g., based on ν₁+ν₂. For example, if ν₁+ν₂ is greater than or equal to a threshold, mapping component 354 or 454 can map (or demap) two TBs; otherwise, mapping component 354 or 454 can map (or demap) one TB. In this regard, for example, spatial layers of different SBs can be counted separately toward total number of layers to determine number of TB (based on whether the total number exceeds the threshold or not). In another example, mapping component 354 or 454 can map (or demap) the number of TBs based on number of TBs determined based on ν₁+number of TBs determined based on ν₂. For example, the threshold can be applied separately to determine two number of TBs, and the consider the sum. In this regard, for example, it may be possible that one or more of the TBs may map to more than one CC or SB. However, this may result in minimum number of TBs=2 for two SBs (or min # of TBs=# of SBs). In the above examples, the threshold may be four layers, though other values may be possible. In addition, the threshold may be configured (e.g., in RRC signaling, MAC-CE, DCI, etc.) or may be stored in a memory of the UE 104 or base station 102/gNB 180 pursuant to a wireless communication technology standard (e.g., 5G NR).

FIG. 10 is a block diagram of a MIMO communication system 1000 including a base station 102 and a UE 104. The MIMO communication system 1000 may illustrate aspects of the wireless communication access network 100 described with reference to FIG. 1. The base station 102 may be an example of aspects of the base station 102 described with reference to FIG. 1. The base station 102 may be equipped with antennas 1034 and 1035, and the UE 104 may be equipped with antennas 1052 and 1053. In the MIMO communication system 1000, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1020 may receive data from a data source. The transmit processor 1020 may process the data. The transmit processor 1020 may also generate control symbols or reference symbols. A transmit MIMO processor 1030 may perform spatial processing (e.g., precoding) on data symbols, control symbols, or reference symbols, if applicable, and may provide output symbol streams to the transmit modulator/demodulators 1032 and 1033. Each modulator/demodulator 1032 through 1033 may process a respective output symbol stream (e.g., for OFDM, etc.) to obtain an output sample stream. Each modulator/demodulator 1032 through 1033 may further process (e.g., convert to analog, amplify, filter, and upconvert) the output sample stream to obtain a DL signal. In one example, DL signals from modulator/demodulators 1032 and 1033 may be transmitted via the antennas 1034 and 1035, respectively.

The UE 104 may be an example of aspects of the UEs 104 described with reference to FIGS. 1 and 3. At the UE 104, the UE antennas 1052 and 1053 may receive the DL signals from the base station 102 and may provide the received signals to the modulator/demodulators 1054 and 1055, respectively. Each modulator/demodulator 1054 through 1055 may condition (e.g., filter, amplify, downconvert, and digitize) a respective received signal to obtain input samples. Each modulator/demodulator 1054 through 1055 may further process the input samples (e.g., for OFDM, etc.) to obtain received symbols. A MIMO detector 1056 may obtain received symbols from the modulator/demodulators 1054 and 1055, perform MIMO detection on the received symbols, if applicable, and provide detected symbols. A receive (Rx) processor 1058 may process (e.g., demodulate, deinterleave, and decode) the detected symbols, providing decoded data for the UE 104 to a data output, and provide decoded control information to a processor(s) 1080, or memory/memories 1082.

The processor(s) 1080 may in some cases execute stored instructions to instantiate a UE communicating component 342 (see e.g., FIGS. 1 and 3).

On the uplink (UL), at the UE 104, a transmit processor 1064 may receive and process data from a data source. The transmit processor 1064 may also generate reference symbols for a reference signal. The symbols from the transmit processor 1064 may be precoded by a transmit MIMO processor 1066 if applicable, further processed by the modulator/demodulators 1054 and 1055 (e.g., for single carrier-FDMA, etc.), and be transmitted to the base station 102 in accordance with the communication parameters received from the base station 102. At the base station 102, the UL signals from the UE 104 may be received by the antennas 1034 and 1035, processed by the modulator/demodulators 1032 and 1033, detected by a MIMO detector 1036 if applicable, and further processed by a receive processor 1038. The receive processor 1038 may provide decoded data to a data output and to the processor(s) 1040 or memory/memories 1042.

The processor(s) 1040 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 1000. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 1000.

The following aspects are illustrative only and aspects thereof may be combined with aspects of other embodiments or teaching described herein, without limitation.

Aspect 1 is a method for wireless communication at a UE including receiving, from a network node, an assignment of multiple subbands associated with a virtual carrier for receiving or transmitting communications, and receiving or transmitting communications over the multiple subbands, where the communications include two or more TBs, and where coded bits for at least one TB of the two or more TBs are mapped to a first set of spatial layers of a first subband of the multiple subbands and to a second set of spatial layers of a second subband of the multiple subbands.

In Aspect 2, the method of Aspect 1 includes where coded bits for each of the two or more TBs are mapped to at least two of the multiple subbands.

In Aspect 3, the method of Aspect 2 includes where the coded bits for each of the two or more TBs are mapped to the at least two of the multiple subbands based at least in part on a function of a first number of spatial layers of a first one of the at least two of the multiple subbands and a second number of spatial layers of a second one of the at least two of the multiple subbands.

In Aspect 4, the method of Aspect 3 includes where the function is whether the first number of spatial layers and the second number of spatial layers are greater than or equal to a threshold number of spatial layers.

In Aspect 5, the method of any of Aspects 3 or 4 includes where the function is whether a difference between the first number of spatial layers and the second number of spatial layers is greater than or equal to a threshold number of spatial layers.

In Aspect 6, the method of any of Aspects 3 to 5 includes where the coded bits for each of the two or more TBs are mapped to the at least two of the multiple subbands based at least in part on a configuration from the network node.

In Aspect 7, the method of any of Aspects 3 to 6 includes where coded bits for a first one of the two or more TBs are mapped to a first portion of the first number of spatial layers of the first one of the at least two of the multiple subbands, coded bits for a second one of the two or more TBs are mapped to a second portion of the first number of spatial layers of the first one of the at least two of the multiple subbands, coded bits for the first one of the two or more TBs are mapped to a third portion of the second number of spatial layers of the second one of the at least two of the multiple subbands, and coded bits for the second one of the two or more TBs are mapped to a fourth portion of the second number of spatial layers of the second one of the at least two of the multiple subbands.

In Aspect 8, the method of Aspect 7 includes where the first portion of the first number of spatial layers is based on to the first number of spatial layers divided by a number of the two or more TBs, the second portion of the first number of spatial layers is a remaining portion of the first number of spatial layers not included in the first portion of the first number of spatial layers, the third portion of the second number of spatial layers is based on to the second number of spatial layers divided by the number of the two or more TBs, and the fourth portion of the second number of spatial layers is a remaining portion of the second number of spatial layers not included in the third portion of the second number of spatial layers.

In Aspect 9, the method of any of Aspects 7 or 8 includes where the first portion of the first number of spatial layers and the second portion of the first number of spatial layers are based on a first subband index of the first one of the at least two of the multiple subbands, and where the third portion of the second number of spatial layers and the fourth portion of the second number of spatial layers are based on a second subband index of the second one of the at least two of the multiple subbands.

In Aspect 10, the method of Aspect 9 includes where the first portion of the first number of spatial layers and the second portion of the first number of spatial layers are based on whether the first subband index is odd or even, and where the third portion of the second number of spatial layers and the fourth portion of the second number of spatial layers are based on whether the second subband index is odd or even.

In Aspect 11, the method of Aspect 10 includes where if the first subband index is odd, the first portion of the first number of spatial layers is based on the first number of spatial layers divided by a number of the two or more TBs, and the second portion of the first number of spatial layers is a remaining portion of the first number of spatial layers not included in the first portion of the first number of spatial layers, if the second subband index is odd, the third portion of the second number of spatial layers is based on the second number of spatial layers divided by the number of the two or more TBs, and the fourth portion of the second number of spatial layers is a remaining portion of the second number of spatial layers not included in the third portion of the second number of spatial layers, if the first subband index is even, the second portion of the first number of spatial layers is based on the first number of spatial layers divided by the number of the two or more TBs, and the first portion of the first number of spatial layers is a remaining portion of the first number of spatial layers not included in the second portion of the first number of spatial layers, and if the second subband index is even, the fourth portion of the second number of spatial layers is based on the second number of spatial layers divided by the number of the two or more TBs, and the third portion of the second number of spatial layers is a remaining portion of the second number of spatial layers not included in the fourth portion of the second number of spatial layers.

In Aspect 12, the method of any of Aspect 7 includes where the first portion of the first number of spatial layers is based on a reference number of spatial layers divided by a number of the two or more TBs, the second portion of the first number of spatial layers is a remaining portion of the first number of spatial layers not included in the first portion of the first number of spatial layers, the third portion of the second number of spatial layers is based on the reference number of spatial layers divided by a number of the two or more TBs, and the fourth portion of the second number of spatial layers is a remaining portion of the second number of spatial layers not included in the third portion of the second number of spatial layers.

In Aspect 13, the method of Aspect 12 includes where the reference number of spatial layers is one of a maximum, minimum, or average number of spatial layers across the at least two of the multiple subbands.

In Aspect 14, the method of Aspect 7 includes the first portion of the first number of spatial layers and the second portion of the first number of spatial layers are a function of one or more of the third portion of the second number of spatial layers or the fourth portion of the second number of spatial layers, or the third portion of the second number of spatial layers and the fourth portion of the second number of spatial layers are a function of one or more of the first portion of the first number of spatial layers or the second portion of the first number of spatial layers.

In Aspect 15, the method of Aspect 7 includes where one or more of the first portion of the first number of spatial layers, the second portion of the first number of spatial layers, the third portion of the second number of spatial layers, or the fourth portion of the second number of spatial layers are based on a configuration from the network node.

In Aspect 16, the method of any of Aspects 1 to 15 includes where the second set of spatial layers of the second subband to which the coded bits for the at least one TB are mapped includes all spatial layers of the second subband, and where coded bits for at least another TB of the two or more TBs are mapped over only one of the multiple subbands.

In Aspect 17, the method of Aspect 16 includes where the coded bits for the at least another TB are mapped over only one of the multiple subbands based at least in part on a function of a first number of spatial layers of a first one of the at least two of the multiple subbands and a second number of spatial layers of a second one of the at least two of the multiple subbands.

In Aspect 18, the method of Aspect 17 includes where the function is whether the first number of spatial layers and the second number of spatial layers are greater than or equal to a threshold number of spatial layers.

In Aspect 19, the method of any of Aspects 17 or 18 includes where the function is whether a difference between the first number of spatial layers and the second number of spatial layers is greater than or equal to a threshold number of spatial layers.

In Aspect 20, the method of any of Aspects 17 to 19 includes where the coded bits for the at least another TB are mapped over only one of the multiple subbands based at least in part on a configuration from the network node.

In Aspect 21, the method of any of Aspects 17 to 20 includes where the at least one TB is associated with a first MCS or redundancy version field of a DCI that schedules resources for the communications.

In Aspect 22, the method of any of Aspects 17 to 21 includes where the at least one TB is selected from the two or more TBs based on whether an index of the one of the multiple subbands is odd or even.

In Aspect 23, the method of any of Aspects 17 to 22 includes, where the at least one TB is selected from the two or more TBs as having one of a higher or lower MCS value.

In Aspect 24, the method of any of Aspects 17 to 23 includes where an index of the at least one TB within the two or more TBs is identified in a configuration from the network node.

In Aspect 25, the method of any of Aspects 1 to 24 includes receiving, from the network node, DCI scheduling resources for receiving or transmitting the two or more TBs, where a number of the two or more TBs is based on one or more of a first number of spatial layers associated with a first one of the at least two of the multiple subbands or a second number of spatial layers associated with a second one of the at least two of the multiple subbands.

In Aspect 26, the method of Aspect 25 includes where the number of the two or more TBs is based on comparing one of a maximum, minimum, or average of the first number of spatial layers and the second number of spatial layers to a threshold.

In Aspect 27, the method of any of Aspects 25 or 26 includes where the number of the two or more TBs is based on comparing a sum of the first number of spatial layers and the second number of spatial layers to a threshold.

In Aspect 28, the method of any of Aspects 25 to 27 includes where the number of the two or more TBs is based on a sum of a first number of TBs determined for the first number of spatial layers and a second number of TBs determined for the second number of spatial layers.

Aspect 29 is a method for wireless communication at a UE that includes receiving, from a network node, DCI scheduling resources for receiving or transmitting communications over multiple subbands, and receiving or transmitting communications over the multiple subbands, where coded bits for a first number of TBs of the communications are mapped to a first set of spatial layers of a first subband of the multiple subbands, and where coded bits for a second number of TBs of the communications are mapped to a second set of spatial layers of a second subband of the multiple subbands.

In Aspect 30, the method of Aspect 29 includes where the first number of TBs and the second number of TBs are based on comparing one of a maximum, minimum, or average of a first number of the first set of spatial layers and a second number of the second set of spatial layers to a threshold.

In Aspect 31, the method of any of Aspects 29 or 30 includes where the first number of TBs and the second number of TBs are based on comparing a sum of a first number of the first set of spatial layers and a second number of the second set of spatial layers to a threshold.

In Aspect 32, the method of any of Aspects 29 to 31 includes where the first number of TBs and the second number of TBs are based on a sum of a first computed number of TBs determined for the first set of spatial layers and a second computed number of TBs determined for the second set of spatial layers.

Aspect 33 is a method for wireless communication at a network node including transmitting, to a UE, an assignment of multiple subbands associated with a virtual carrier for receiving or transmitting communications, and receiving or transmitting communications over the multiple subbands, where the communications include two or more TBs, and where coded bits for at least one TB of the two or more TBs are mapped to a first set of spatial layers of a first subband of the multiple subbands and to a second set of spatial layers of a second subband of the multiple subbands.

In Aspect 34, the method of Aspect 33 includes where coded bits for each of the two or more TBs are mapped to at least two of the multiple subbands.

In Aspect 35, the method of Aspect 34 includes where the coded bits for each of the two or more TBs are mapped to the at least two of the multiple subbands based at least in part on a function of a first number of spatial layers of a first one of the at least two of the multiple subbands and a second number of spatial layers of a second one of the at least two of the multiple subbands.

In Aspect 36, the method of Aspect 35 includes where the function is whether the first number of spatial layers and the second number of spatial layers are greater than or equal to a threshold number of spatial layers.

In Aspect 37, the method of any of Aspects 35 or 36 includes where the function is whether a difference between the first number of spatial layers and the second number of spatial layers is greater than or equal to a threshold number of spatial layers.

In Aspect 38, the method of any of Aspects 35 to 37 includes where the coded bits for each of the two or more TBs are mapped to the at least two of the multiple subbands based at least in part on a configuration from the network node.

In Aspect 39, the method of any of Aspects 35 to 38 includes where coded bits for a first one of the two or more TBs are mapped to a first portion of the first number of spatial layers of the first one of the at least two of the multiple subbands, coded bits for a second one of the two or more TBs are mapped to a second portion of the first number of spatial layers of the first one of the at least two of the multiple subbands, coded bits for the first one of the two or more TBs are mapped to a third portion of the second number of spatial layers of the second one of the at least two of the multiple subbands, and coded bits for the second one of the two or more TBs are mapped to a fourth portion of the second number of spatial layers of the second one of the at least two of the multiple subbands.

In Aspect 40, the method of Aspect 39 includes where the first portion of the first number of spatial layers is based on to the first number of spatial layers divided by a number of the two or more TBs, the second portion of the first number of spatial layers is a remaining portion of the first number of spatial layers not included in the first portion of the first number of spatial layers, the third portion of the second number of spatial layers is based on to the second number of spatial layers divided by the number of the two or more TBs, and the fourth portion of the second number of spatial layers is a remaining portion of the second number of spatial layers not included in the third portion of the second number of spatial layers.

In Aspect 41, the method of any of Aspects 39 or 40 includes where the first portion of the first number of spatial layers and the second portion of the first number of spatial layers are based on a first subband index of the first one of the at least two of the multiple subbands, and where the third portion of the second number of spatial layers and the fourth portion of the second number of spatial layers are based on a second subband index of the second one of the at least two of the multiple subbands.

In Aspect 42, the method of Aspect 41 includes where the first portion of the first number of spatial layers and the second portion of the first number of spatial layers are based on whether the first subband index is odd or even, and where the third portion of the second number of spatial layers and the fourth portion of the second number of spatial layers are based on whether the second subband index is odd or even.

In Aspect 43, the method of Aspect 42 includes if the first subband index is odd, the first portion of the first number of spatial layers is based on the first number of spatial layers divided by a number of the two or more TBs, and the second portion of the first number of spatial layers is a remaining portion of the first number of spatial layers not included in the first portion of the first number of spatial layers, if the second subband index is odd, the third portion of the second number of spatial layers is based on the second number of spatial layers divided by the number of the two or more TBs, and the fourth portion of the second number of spatial layers is a remaining portion of the second number of spatial layers not included in the third portion of the second number of spatial layers, if the first subband index is even, the second portion of the first number of spatial layers is based on the first number of spatial layers divided by the number of the two or more TBs, and the first portion of the first number of spatial layers is a remaining portion of the first number of spatial layers not included in the second portion of the first number of spatial layers, and if the second subband index is even, the fourth portion of the second number of spatial layers is based on the second number of spatial layers divided by the number of the two or more TBs, and the third portion of the second number of spatial layers is a remaining portion of the second number of spatial layers not included in the fourth portion of the second number of spatial layers.

In Aspect 44, the method of Aspect 39 includes where the first portion of the first number of spatial layers is based on a reference number of spatial layers divided by a number of the two or more TBs, the second portion of the first number of spatial layers is a remaining portion of the first number of spatial layers not included in the first portion of the first number of spatial layers, the third portion of the second number of spatial layers is based on the reference number of spatial layers divided by a number of the two or more TBs, and the fourth portion of the second number of spatial layers is a remaining portion of the second number of spatial layers not included in the third portion of the second number of spatial layers.

In Aspect 45, the method of Aspect 44 includes where the reference number of spatial layers is one of a maximum, minimum, or average number of spatial layers across the at least two of the multiple subbands.

In Aspect 46, the method of Aspect 39 includes the first portion of the first number of spatial layers and the second portion of the first number of spatial layers are a function of one or more of the third portion of the second number of spatial layers or the fourth portion of the second number of spatial layers, or the third portion of the second number of spatial layers and the fourth portion of the second number of spatial layers are a function of one or more of the first portion of the first number of spatial layers or the second portion of the first number of spatial layers.

In Aspect 47, the method of Aspect 39 includes where one or more of the first portion of the first number of spatial layers, the second portion of the first number of spatial layers, the third portion of the second number of spatial layers, or the fourth portion of the second number of spatial layers are based on a configuration from the network node.

In Aspect 48, the method of any of Aspects 33 to 47 includes where the second set of spatial layers of the second subband to which the coded bits for the at least one TB are mapped includes all spatial layers of the second subband, and where coded bits for at least another TB of the two or more TBs are mapped over only one of the multiple subbands.

In Aspect 49, the method of Aspect 48 includes where the coded bits for the at least another TB are mapped over only one of the multiple subbands based at least in part on a function of a first number of spatial layers of a first one of the at least two of the multiple subbands and a second number of spatial layers of a second one of the at least two of the multiple subbands.

In Aspect 50, the method of Aspect 49 includes where the function is whether the first number of spatial layers and the second number of spatial layers are greater than or equal to a threshold number of spatial layers.

In Aspect 51, the method of any of Aspects 49 or 50 includes where the function is whether a difference between the first number of spatial layers and the second number of spatial layers is greater than or equal to a threshold number of spatial layers.

In Aspect 52, the method of any of Aspects 49 to 51 includes where the coded bits for the at least another TB are mapped over only one of the multiple subbands based at least in part on a configuration from the network node.

In Aspect 53, the method of any of Aspects 49 to 52 includes where the at least one TB is associated with a first MCS or redundancy version field of a DCI that schedules resources for the communications.

In Aspect 54, the method of any of Aspects 49 to 53 includes where the at least one TB is selected from the two or more TBs based on whether an index of the one of the multiple subbands is odd or even.

In Aspect 55, the method of any of Aspects 49 to 54 includes where the at least one TB is selected from the two or more TBs as having one of a higher or lower MCS value.

In Aspect 56, the method of any of Aspects 49 to 55 includes where an index of the at least one TB within the two or more TBs is identified in a configuration from the network node.

In Aspect 57, the method of any of Aspects 33 to 56 includes transmitting, for the UE, DCI scheduling resources for receiving or transmitting the two or more TBs, where a number of the two or more TBs is based on one or more of a first number of spatial layers associated with a first one of the at least two of the multiple subbands or a second number of spatial layers associated with a second one of the at least two of the multiple subbands.

In Aspect 58, the method of Aspect 57 includes where the number of the two or more TBs is based on comparing one of a maximum, minimum, or average of the first number of spatial layers and the second number of spatial layers to a threshold.

In Aspect 59, the method of any of Aspects 57 or 58 includes where the number of the two or more TBs is based on comparing a sum of the first number of spatial layers and the second number of spatial layers to a threshold.

In Aspect 60, the method of any of Aspects 57 to 59 includes where the number of the two or more TBs is based on a sum of a first number of TBs determined for the first number of spatial layers and a second number of TBs determined for the second number of spatial layers.

Aspect 61 is a method for wireless communication at a network node including transmitting, to a UE, DCI scheduling resources for receiving or transmitting communications over multiple subbands, and receiving or transmitting communications over the multiple subbands, where coded bits for a first number of TBs of the communications are mapped to a first set of spatial layers of a first subband of the multiple subbands, and where coded bits for a second number of TBs of the communications are mapped to a second set of spatial layers of a second subband of the multiple subbands.

In Aspect 62, the method of Aspect 61 includes where the first number of TBs and the second number of TBs are based on comparing one of a maximum, minimum, or average of a first number of the first set of spatial layers and a second number of the second set of spatial layers to a threshold.

In Aspect 63, the method of any of Aspects 61 or 62 includes where the first number of TBs and the second number of TBs are based on comparing a sum of a first number of the first set of spatial layers and a second number of the second set of spatial layers to a threshold.

In Aspect 64, the method of any of Aspects 61 to 63 includes where the first number of TBs and the second number of TBs are based on a sum of a first computed number of TBs determined for the first set of spatial layers and a second computed number of TBs determined for the second set of spatial layers.

Aspect 65 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 64.

Aspect 66 is an apparatus for wireless communication including means for performing any of the methods of Aspects 1 to 64.

Aspect 67 is one or more computer-readable media including code executable by one or more processors for wireless communications, the code including code for performing any of the methods of Aspects 1 to 64.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive, from a network node, an assignment of multiple subbands associated with a virtual carrier for receiving or transmitting communications; and
receive or transmit communications over the multiple subbands, wherein the communications include two or more transport blocks (TBs), and wherein coded bits for at least one TB of the two or more TBs are mapped to a first set of spatial layers of a first subband of the multiple subbands and to a second set of spatial layers of a second subband of the multiple subbands.

2. The apparatus of claim 1, wherein coded bits for each of the two or more TBs are mapped to at least two of the multiple subbands.

3. The apparatus of claim 2, wherein the coded bits for each of the two or more TBs are mapped to the at least two of the multiple subbands based at least in part on a function of a first number of spatial layers of a first one of the at least two of the multiple subbands and a second number of spatial layers of a second one of the at least two of the multiple subbands.

4. The apparatus of claim 3, wherein the function is whether the first number of spatial layers and the second number of spatial layers are greater than or equal to a threshold number of spatial layers.

5. The apparatus of claim 3, wherein the function is whether a difference between the first number of spatial layers and the second number of spatial layers is greater than or equal to a threshold number of spatial layers.

6. The apparatus of claim 3, wherein the coded bits for each of the two or more TBs are mapped to the at least two of the multiple subbands based at least in part on a configuration from the network node.

7. The apparatus of claim 3, wherein coded bits for a first one of the two or more TBs are mapped to a first portion of the first number of spatial layers of the first one of the at least two of the multiple subbands, coded bits for a second one of the two or more TBs are mapped to a second portion of the first number of spatial layers of the first one of the at least two of the multiple subbands, coded bits for the first one of the two or more TBs are mapped to a third portion of the second number of spatial layers of the second one of the at least two of the multiple subbands, and coded bits for the second one of the two or more TBs are mapped to a fourth portion of the second number of spatial layers of the second one of the at least two of the multiple subbands.

8. The apparatus of claim 7, wherein the first portion of the first number of spatial layers is based on to the first number of spatial layers divided by a number of the two or more TBs, the second portion of the first number of spatial layers is a remaining portion of the first number of spatial layers not included in the first portion of the first number of spatial layers, the third portion of the second number of spatial layers is based on to the second number of spatial layers divided by the number of the two or more TBs, and the fourth portion of the second number of spatial layers is a remaining portion of the second number of spatial layers not included in the third portion of the second number of spatial layers.

9. The apparatus of claim 7, wherein the first portion of the first number of spatial layers and the second portion of the first number of spatial layers are based on a first subband index of the first one of the at least two of the multiple subbands, and wherein the third portion of the second number of spatial layers and the fourth portion of the second number of spatial layers are based on a second subband index of the second one of the at least two of the multiple subbands.

10. The apparatus of claim 9, wherein the first portion of the first number of spatial layers and the second portion of the first number of spatial layers are based on whether the first subband index is odd or even, and wherein the third portion of the second number of spatial layers and the fourth portion of the second number of spatial layers are based on whether the second subband index is odd or even.

11. The apparatus of claim 10, wherein the one or more processors are, individually or in combination, configured to execute the instructions to cause the apparatus to:
if the first subband index is odd, map the coded bits for each of the two or more TBs to the at least two of the multiple subbands for transmitted communications, or demap the coded bits for each of the two or more TBs from the at least two of the multiple subbands for received communications, such that the first portion of the first number of spatial layers is based on the first number of spatial layers divided by a number of the two or more TBs, and the second portion of the first number of spatial layers is a remaining portion of the first number of spatial layers not included in the first portion of the first number of spatial layers;
if the second subband index is odd, map the coded bits for each of the two or more TBs to the at least two of the multiple subbands for transmitted communications, or demap the coded bits for each of the two or more TBs from the at least two of the multiple subbands for received communications, such that the third portion of the second number of spatial layers is based on the second number of spatial layers divided by the number of the two or more TBs, and the fourth portion of the second number of spatial layers is a remaining portion of the second number of spatial layers not included in the third portion of the second number of spatial layers;
if the first subband index is even, map the coded bits for each of the two or more TBs to the at least two of the multiple subbands for transmitted communications, or demap the coded bits for each of the two or more TBs from the at least two of the multiple subbands for received communications, such that the second portion of the first number of spatial layers is based on the first number of spatial layers divided by the number of the two or more TBs, and the first portion of the first number of spatial layers is a remaining portion of the first number of spatial layers not included in the second portion of the first number of spatial layers; and
if the second subband index is even, map the coded bits for each of the two or more TBs to the at least two of the multiple subbands for transmitted communications, or demap the coded bits for each of the two or more TBs from the at least two of the multiple subbands for received communications, such that the fourth portion of the second number of spatial layers is based on the second number of spatial layers divided by the number of the two or more TBs, and the third portion of the second number of spatial layers is a remaining portion of the second number of spatial layers not included in the fourth portion of the second number of spatial layers.

12. The apparatus of claim 7, wherein the first portion of the first number of spatial layers is based on a reference number of spatial layers divided by a number of the two or more TBs, the second portion of the first number of spatial layers is a remaining portion of the first number of spatial layers not included in the first portion of the first number of spatial layers, the third portion of the second number of spatial layers is based on the reference number of spatial layers divided by a number of the two or more TBs, and the fourth portion of the second number of spatial layers is a remaining portion of the second number of spatial layers not included in the third portion of the second number of spatial layers.

13. The apparatus of claim 12, wherein the reference number of spatial layers is one of a maximum, minimum, or average number of spatial layers across the at least two of the multiple subbands.

14. The apparatus of claim 7, wherein:
the first portion of the first number of spatial layers and the second portion of the first number of spatial layers are a function of one or more of the third portion of the second number of spatial layers or the fourth portion of the second number of spatial layers; or
the third portion of the second number of spatial layers and the fourth portion of the second number of spatial layers are a function of one or more of the first portion of the first number of spatial layers or the second portion of the first number of spatial layers.

15. The apparatus of claim 7, wherein one or more of the first portion of the first number of spatial layers, the second portion of the first number of spatial layers, the third portion of the second number of spatial layers, or the fourth portion of the second number of spatial layers are based on a configuration from the network node.

16. The apparatus of claim 1, wherein the second set of spatial layers of the second subband to which the coded bits for the at least one TB are mapped includes all spatial layers of the second subband, and wherein coded bits for at least another TB of the two or more TBs are mapped over only one of the multiple subbands.

17. The apparatus of claim 16, wherein the coded bits for the at least another TB are mapped over only one of the multiple subbands based at least in part on a function of a first number of spatial layers of a first one of the at least two of the multiple subbands and a second number of spatial layers of a second one of the at least two of the multiple subbands.

18. The apparatus of claim 17, wherein the function is one of:
whether the first number of spatial layers and the second number of spatial layers are greater than or equal to a threshold number of spatial layers; or
whether a difference between the first number of spatial layers and the second number of spatial layers is greater than or equal to a threshold number of spatial layers.

19. The apparatus of claim 17, wherein the coded bits for the at least another TB are mapped over only one of the multiple subbands based at least in part on a configuration from the network node.

20. The apparatus of claim 17, wherein the at least one TB is one of:
associated with a first modulation and coding scheme (MCS) or redundancy version field of a downlink control information (DCI) that schedules resources for the communications;
selected from the two or more TBs based on whether an index of the one of the multiple subbands is odd or even; or
selected from the two or more TBs as having one of a higher or lower modulation and coding scheme (MCS) value.

21. The apparatus of claim 17, wherein an index of the at least one TB within the two or more TBs is identified in a configuration from the network node.

22. The apparatus of claim 1, wherein the one or more processors are, individually or in combination, configured to execute the instructions to cause the apparatus to receive, from the network node, downlink control information (DCI) scheduling resources for receiving or transmitting the two or more TBs, wherein a number of the two or more TBs is based on one or more of a first number of spatial layers associated with a first one of the at least two of the multiple subbands or a second number of spatial layers associated with a second one of the at least two of the multiple subbands.

23. The apparatus of claim 22, wherein the number of the two or more TBs is based on one of:
comparing one of a maximum, minimum, or average of the first number of spatial layers and the second number of spatial layers to a threshold;
comparing a sum of the first number of spatial layers and the second number of spatial layers to a threshold; or
a sum of a first number of TBs determined for the first number of spatial layers and a second number of TBs determined for the second number of spatial layers.

24. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
transmit, to a user equipment (UE), an assignment of multiple subbands associated with a virtual carrier for receiving or transmitting communications; and
receive or transmit communications over the multiple subbands, wherein the communications include two or more transport blocks (TBs), and wherein coded bits for at least one TB of the two or more TBs are mapped to a first set of spatial layers of a first subband of the multiple subbands and to a second set of spatial layers of a second subband of the multiple subbands.

25. The apparatus of claim 24, wherein coded bits for each of the two or more TBs are mapped to at least two of the multiple subbands.

26. The apparatus of claim 25, wherein the coded bits for each of the two or more TBs are mapped to the at least two of the multiple subbands based at least in part on a function of a first number of spatial layers of a first one of the at least two of the multiple subbands and a second number of spatial layers of a second one of the at least two of the multiple subbands.

27. A method for wireless communication at a user equipment (UE), comprising:
receiving, from a network node, an assignment of multiple subbands associated with a virtual carrier for receiving or transmitting communications; and
receiving or transmitting communications over the multiple subbands, wherein the communications include two or more transport blocks (TBs), and wherein coded bits for at least one TB of the two or more TBs are mapped to a first set of spatial layers of a first subband of the multiple subbands and to a second set of spatial layers of a second subband of the multiple subbands.

28. The method of claim 27, wherein coded bits for each of the two or more TBs are mapped to at least two of the multiple subbands.

29. A method for wireless communication at a network node, comprising:
transmitting, to a user equipment (UE), an assignment of multiple subbands associated with a virtual carrier for receiving or transmitting communications; and
receiving or transmitting communications over the multiple subbands, wherein the communications include two or more transport blocks (TBs), and wherein coded bits for at least one TB of the two or more TBs are mapped to a first set of spatial layers of a first subband of the multiple subbands and to a second set of spatial layers of a second subband of the multiple subbands.

30. The method of claim 29, wherein coded bits for each of the two or more TBs are mapped to at least two of the multiple subbands.
